(19) United States
(12) Patent Application Publication
(10) Pub. No.: US 2020/0086753 A1
(43) Pub. Date: Mar. 19, 2020

(54) MOBILE CHARGING SYSTEM AND METHOD FOR CHARGING AN ELECTRIC VEHICLE

(71) Applicants: STATE GRID CHONGQING ELECTRIC POWER CO. ELECTRIC POWER RESEARCH INSTITUTE, Chongqing (CN); STATE GRID CHONGQING ELECTRIC POWER COMPANY, Chongqing (CN); STATE GRID CORPORATION OF CHINA, Beijing (CN)

(72) Inventors: Xingzhe HOU, Chongqing (CN); Bin ZHU, Chongqing (CN); Yuechun LV, Chongqing (CN); Guojun HE, Chongqing (CN); Zhi LI, Chongqing (CN); Yongxiang LIU, Chongqing (CN); Hongliang SUN, Chongqing (CN); Yi LONG, Chongqing (CN); Jing ZHANG, Chongqing (CN); Huicai WANG, Chongqing (CN); Tingting XU, Chongqing (CN); Li ZHOU, Chongqing (CN); Lin GONG, Chongqing (CN); Yongliang JI, Chongqing (CN)

(21) Appl. No.: 15/750,879

(22) PCT Filed: Dec. 12, 2017
(86) PCT No.: PCT/CN2017/115742

§ 371 Date: Feb. 7, 2018

(30) Foreign Application Priority Data
Sep. 13, 2017 (CN) 201710822955.9

(51) Int. Cl. B60L 53/35; B60L 53/53; B60L 53/16; B60L 53/68; G05D 1/12; H02J 7/02; H02J 7/00

(52) U.S. Cl. CPC B60L 53/35; B60L 53/53; B60L 53/16; B60L 53/68; B60L 2240/62; H02J 7/02; H02J 7/0047; H02J 7/00032; G05D 1/12

(57) ABSTRACT

A method for charging an electric vehicle includes steps that a master device sorts multiple received charging request information according to a preset sorting rule, where the charging request information includes position information of the electric vehicle to be charged; the master device sends a charging instruction to a charging system according to a sorting result; the charging system receives and processes the charging instruction and then transmits the charging instruction to an automated guided vehicle; and the automated guided vehicle travels, according to the position information, to a position of the electric vehicle to be charged, and charges the electric vehicle to be charged.

### TECHNICAL FIELD

The present disclosure relates to techniques for charging an electric vehicle and, in particular, to a mobile charging system and method for charging an electric vehicle.

### BACKGROUND

With the development of electric vehicles, the problem of difficulty and inconvenience in charging electric vehicles is becoming increasingly prominent. At present, electric vehicles are mainly charged by stationary AC or DC charging spots. An AC charging spot is connected to a nearby 0.38 kV low-voltage distribution network and supplies 220 V or 380 V AC power. The AC power is outputted from the AC charging spot and then is converted into DC power by an on-board charger. a DC charging spot receives 380 V AC power supplied by a public transformer or a private transformer, and outputs DC power required for batteries of electric vehicles. In the related art, a user has to drive a vehicle to a place equipped with a charging spot to charge the vehicle, and drives away when the vehicle is fully charged. This is time-consuming and inconvenient, causing a low utilization ratio of charging spots and affecting popularization and application of electric vehicles.

### SUMMARY

The present disclosure provides a mobile charging system and method for charging an electric vehicle, significantly reducing the number of charging spots to be constructed. In this method, an energy storage battery built into the electric vehicle can be fully charged in an orderly manner in an electricity consumption trough, thus reducing an impact on a distribution network, shaving a peak load and saving a lot of distribution network reconstruction costs.

A method for charging an electric vehicle includes steps that a master device sorts multiple received charging request information according to a preset sorting rule, where the charging request information includes position information of the electric vehicle to be charged; the master device sends a charging instruction to a charging system according to a sorting result;

the charging system receives and processes the charging instruction and then transmits the charging instruction to an automated guided vehicle; and the automated guided vehicle travels, according to the position information, to a position of the electric vehicle to be charged, and charges the electric vehicle to be charged.

Optionally, the step in which the master device sorts the multiple received charging request information according to the preset sorting rule includes that after receiving the charging request information, the master device sorts the charging request information according to at least one of an existing order situation, an emergency degree of a charging request, a determination on whether to accept an expedited fee, a distance between a parking position of the electric vehicle to be charged and a charging device, and route planning for reaching the parking position of the electric vehicle to be charged, where the sorting result is adjustable in real time.

Optionally, the charging request information is sent by a mobile application (APP), a personal computer (PC) or a webpage of a charging website.

Optionally, the charging system transmits the charging instruction to the automated guided vehicle via at least one of the following transmission modes: a General Packet Radio Service (GPRS), a Wireless Fidelity (Wi-Fi) and a ZigBee.

Optionally, the automated guided vehicle includes a battery storage compartment and charges the electric vehicle to be charged through a battery in the battery storage compartment.

Optionally, the battery is further configured to charge the automated guided vehicle.

The present disclosure further provides a mobile charging system for implementing any method described above. The system includes an automated guided vehicle, a mobile positioning platform, a battery storage compartment, a battery grabbing robot arm, an AC power plug, a power switcher, a charging robot arm, a charging plug, a master device, a communication device and a metering device.

The master device is configured to transmit a movement instruction to the mobile positioning platform.

The mobile positioning platform is connected to the master device and configured to receive the movement instruction transmitted by the master device.

The automated guided vehicle is configured to automatically travel along a route which is preset according to the movement instruction by the mobile positioning platform.

The battery storage compartment is located in the automated guided vehicle and configured to store a battery, where the battery is configured to charge an electric vehicle to be charged.

The master device is configured to control the battery grabbing robot arm to grab the battery in the battery storage compartment in order to put the battery in the battery storage compartment and take the battery out of the battery storage compartment.

The master device is further configured to control intelligent distribution for a power supply from the battery storage compartment.

The power switcher is configured to switch between the battery storage compartment and the AC power plug to switch between the power supplies from the battery storage compartment and the AC power plug for charging the electric vehicle.

The master device is further configured to control an operation of the charging robot arm.

The charging plug is connected to the charging robot arm and configured to charge the electric vehicle, where the charging robot arm is configured to enable the charging plug to be inserted into a charging socket of the electric vehicle.

The communication device is configured for communication between the master device and a background management system.

The metering device is connected to the master device and configured to meter a charging amount and a charging duration of the electric vehicle and transmit information about the charging amount and the charging duration to the master device.

The master device is further configured to transmit user information and order information generated from the information about the charging amount and the charging duration to a user through the background management system.

Optionally, the charging robot arm includes an image recognition device, a control device, a manipulator and a motor drive device.

The image recognition device is connected to the control device and configured to acquire image information.

The control device is connected to the motor drive device and configured to control the motor drive device according to the image information.

The motor drive device is connected to the manipulator and configured to drive the manipulator to operate.

Optionally, the master device is configured to make route planning and an anti-collision design for the automated guided vehicle by means of electromagnetic induction guidance, laser guidance or visual guidance, and control the automated guided vehicle.

Optionally, the battery is further configured to charge the automated guided vehicle.

Optionally, the power switcher is configured to be connected to the AC power plug when the electric vehicle to be charged is charged by an AC power supply, where the AC power plug is configured to be connected to the AC power supply.

The present disclosure further provides a computer program product including a computer program stored on a non-transient computer-readable storage medium, where the computer program includes program instructions which, when executed by a computer, enable the computer to execute any method described above.

The present disclosure further provides a computer-readable storage medium configured to store computer-executable instructions for executing any method described above.

The present disclosure changes a user's parking time at a destination, a work place, and a dwelling place, etc., into a charging duration, thereby bringing much convenience to the user.

A power supply mode provided by the present disclosure is flexible and easy to operate and use.

Mobile charging facilities have no space limitations in the process of charging operation and thus are applicable for parked electric vehicles.

The present disclosure can significantly reduce the number of charging spots to be constructed. In the present disclosure, an energy storage battery built into the electric vehicle can be fully charged in an orderly manner in an electricity consumption trough, thus reducing an impact on a distribution network, shaving a peak load and saving a lot of distribution network reconstruction costs.

### BRIEF DESCRIPTION OF DRAWINGS

FIG. 1 is a flowchart of a method for charging an electric vehicle according to an embodiment.

FIG. 2 is a flowchart of another method for charging an electric vehicle according to an embodiment.

FIG. 3 is a connection diagram of a mobile charging system for charging an electric vehicle according to an embodiment.

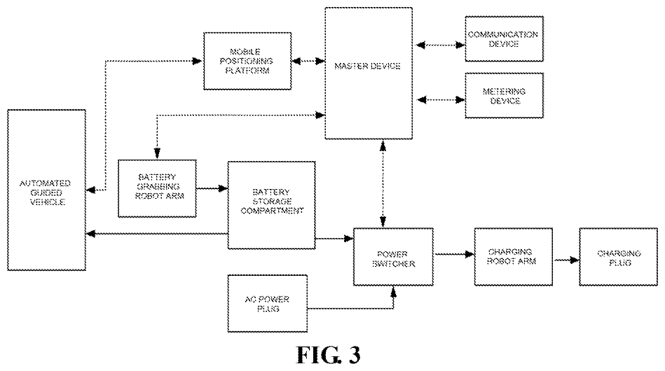

FIG. 4 is a connection diagram of a charging robot arm according to an embodiment.

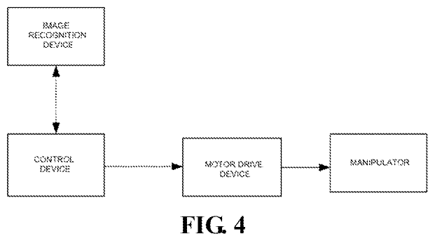

### DETAILED DESCRIPTION

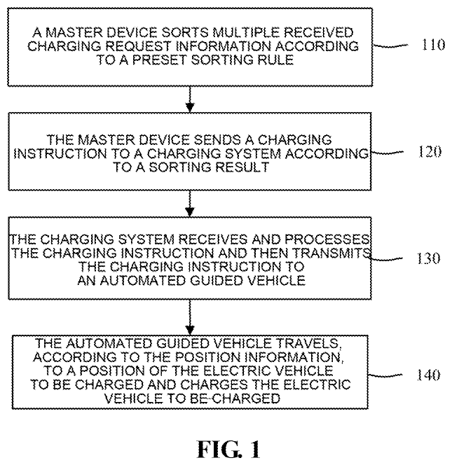

FIG. 1 is a flowchart of a method for charging an electric vehicle according to an embodiment. As illustrated in FIG. 1, the method includes steps 110 through 140.

In step 110, a master device sorts multiple received charging request information according to a preset sorting rule, where the charging request information includes position information of the electric vehicle to be charged.

In step 120, the master device sends a charging instruction to a charging system according to a sorting result.

In step 130, the charging system receives and processes the charging instruction and then transmits the charging instruction to an automated guided vehicle.

In step 140, the automated guided vehicle travels, according to the position information, to a position of the electric vehicle to be charged, and charges the electric vehicle to be charged.

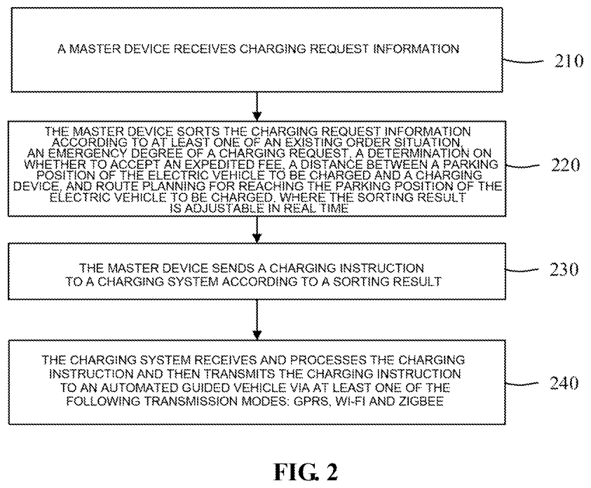

The method provided by this embodiment can significantly reduce the number of charging spots to be constructed. In this method, an energy storage battery built into the electric vehicle can be fully charged in an orderly manner in an electricity consumption trough, thus reducing an impact on a distribution network, shaving a peak load and saving a lot of distribution network reconstruction costs. As illustrated in FIG. 2, based on the above embodiment, this embodiment provides another method for charging an electric vehicle. The method includes steps 210 through 250.

In step 210, a master device receives charging request information. Optionally, the charging request information in this embodiment is sent by a mobile application (APP), a personal computer (PC) or a webpage of a charging website.

In step 220, the master device sorts the charging request information according to at least one of an existing order situation, an emergency degree of a charging request, a determination on whether to accept an expedited fee, a distance between a parking position of the electric vehicle to be charged and a charging device, and route planning for reaching the parking position of the electric vehicle to be charged. The sorting result is adjustable in real time.

In step 230, the master device sends a charging instruction to a charging system according to a sorting result.

In step 240, the charging system receives and processes the charging instruction and then transmits the charging instruction to an automated guided vehicle via at least one of the following transmission modes: a General Packet Radio Service (GPRS), a Wireless Fidelity

(Wi-Fi) and a ZigBee.

In step 250, the automated guided vehicle travels, according to position information, to a position of the electric vehicle to be charged and charges the electric vehicle to be charged through a battery in a battery storage compartment. Optionally, the battery storage compartment is further configured to charge the automated guided vehicle.

The method provided by this embodiment can significantly reduce the number of charging spots to be constructed. In this method, an energy storage battery built into the electric vehicle can be fully charged in an orderly manner in an electricity consumption trough, thus reducing an impact on a distribution network, shaving a peak load and saving a lot of distribution network reconstruction costs.

Embodiments of the present disclosure further provide a mobile charging system for charging an electric vehicle. The system includes an automated guided vehicle, a mobile positioning platform, a battery storage compartment, a battery grabbing robot arm, an AC power plug, a power switcher, a charging robot arm, a charging plug, a master device, a communication device and a metering device.

The master device is configured to transmit a movement instruction to the mobile positioning platform.

The mobile positioning platform is connected to the master device and configured to receive the movement instruction transmitted by the master device.

The automated guided vehicle is configured to automatically travel along a route which is preset according to the movement instruction by the mobile positioning platform.

The battery storage compartment is located in the automated guided vehicle and configured to store a battery, where the battery is configured to charge an electric vehicle to be charged.

The master device is configured to control the battery grabbing robot arm to grab the battery in the battery storage compartment in order to put the battery in the battery storage compartment and take the battery out of the battery storage compartment.

The master device is further configured to control intelligent distribution for a power supply from the battery storage compartment.

The power switcher is configured to switch between the battery storage compartment and the AC power plug to switch between power supplies from the battery storage compartment and the AC power plug for charging the electric vehicle.

The master device is further configured to control an operation of the charging robot arm.

The charging plug is connected to the charging robot arm and configured to charge the electric vehicle, where the charging robot arm is configured to enable the charging plug to be inserted into a charging socket of the electric vehicle.

The communication device is configured for communication between the master device and a background management system.

The metering device is connected to the master device and configured to meter a charging amount and a charging duration of the electric vehicle and transmit information about the charging amount and the charging duration to the master device.

The master device is further configured to transmit user information and also order information generated from the information about the charging amount and the charging duration to a user through the background management system.

The charging robot arm includes an image recognition device, a control device, a manipulator and a motor drive device.

The image recognition device is connected to the control device and configured to acquire image information.

The control device is connected to the motor drive device and configured to control the motor drive device according to the image information.

The motor drive device is connected to the manipulator and configured to drive the manipulator to operate.

The master device is configured to make route planning and an anti-collision design for the automated guided vehicle by means of electromagnetic induction guidance, laser guidance or visual guidance, and control the automated guided vehicle.

The battery is further configured to charge the automated guided vehicle.

The power switcher is configured to be connected to the AC power plug when the electric vehicle to be charged is charged by an AC power supply, where the AC power plug is configured to be connected to the AC power supply.

When the electric vehicle to be charged is charged by an AC power supply, the AC power plug is externally connected to the AC power supply.

Embodiments of the present disclosure further provide a computer program product including a computer program stored on a non-transient computer-readable storage medium, where the computer program includes program instructions that, when executed by a computer, enable the computer to execute any method described above.

Embodiments of the present disclosure further provide a computer-readable storage medium configured to store computer-executable instructions for executing any method described above.

An operating process of embodiments of the present disclosure includes the steps described below.

After receiving charging request information, a master device sorts the charging request information according to an existing order situation, an emergency degree of a charging request, a determination on whether to accept an expedited fee, a distance between a parking position of an electric vehicle to be charged and a charging device, and route planning for reaching the parking position of the electric vehicle to be charged. A sorting result can be adjusted as needed in real time to achieve orderly charging.

After the charging device responds to the charging request, an automated guided vehicle automatically travels along a route that is set according to a movement instruction by a mobile positioning platform, and reaches the electric vehicle to be charged.

The master device sends an operation instruction to a charging robot arm. The charging robot arm acquires image information through an image recognition device. The master device controls an operation of a motor drive device through the image information. The motor drive device drives a manipulator to operate and enable a charging plug connected with the charging robot arm to be inserted into a charging socket of the electric vehicle.

After the master device detects that the charging plug has been connected to the electric vehicle and is ready for charging, the master device sends a prompt message indicating connection completion and indicating, if a suitable AC power supply is available near the electric vehicle to be charged, to manually connect an AC power plug to the external AC power supply to charge the electric vehicle.

Within 90 seconds after the prompt message is sent out, if the master device detects that the AC power plug has been connected to the external AC power supply, a power switcher is controlled to operate and the AC power supply is used to charge the electric vehicle.

Within 90 seconds after the prompt message is sent out, if the master device does not detect that the AC power plug has been connected to the external AC power supply, the power switcher does not operate and a battery in a battery storage compartment is used to charge the electric vehicle by default.

After the charging is completed, a metering device meters a charging amount and a charging duration and transmits information about the charging amount and the charging duration to the master device.

The master device transmits order information generated from the information about the charging amount and the charging duration as well as payment information to the user through a background management system.

The master device responds to a next charging request and begins a next charging process.

The mobile charging system for charging an electric vehicle provided by embodiments of the present disclosure eliminates the need for a user to make a special trip to a charging station, changes a parking time at a destination, a work place and a dwelling place into a charging duration, allows the parking time to be utilized as the charging duration and reduces the number of charging spots to be constructed. Moreover, an energy storage battery built into the electric vehicle can be fully charged in an orderly manner in an electricity consumption trough, thus reducing an impact on a distribution network, shaving a peak load and saving a lot of distribution network reconstruction costs.

### INDUSTRIAL APPLICABILITY

A mobile charging system and method for charging an electric vehicle provided by the present disclosure significantly reduce the number of charging spots to be constructed. In this method, an energy storage battery built into the electric vehicle can be fully charged in an electricity consumption trough, thus reducing an impact on a distribution network, shaving a peak load and saving a lot of distribution network reconstruction costs.

1. A method for charging an electric vehicle, comprising:
using a master device to sort a plurality of received charging request information according to a preset sorting rule, wherein the charging request information comprises position information of the electric vehicle to be charged;
using the master device to send a charging instruction to a charging system according to a sorting result;
using the charging system to receive and process the charging instruction and then transmit the charging instruction to an automated guided vehicle; and
using the automated guided vehicle to travel, according to the position information, to a position of the electric vehicle to be charged and charge the electric vehicle to be charged.

2. The method of claim 1, wherein the using the master device to sort the plurality of received charging request information according to the preset sorting rule comprises:
using the master device, after the master device receives the charging request information, to sort the charging request information according to at least one of an existing order situation, an emergency degree of a charging request, a determination on whether to accept an expedited fee, a distance between a parking position of the electric vehicle to be charged and a charging device, and route planning for reaching the parking position of the electric vehicle to be charged, wherein the sorting result is adjustable in real time.

3. The method of claim 1, wherein the charging request information is sent by a mobile application (APP), a personal computer (PC) or a webpage of a charging website.

4. The method of claim 1, wherein the charging system transmits the charging instruction to the automated guided vehicle via at least one of the following transmission modes: a General Packet Radio Service (GPRS), a Wireless Fidelity (Wi-Fi) and a ZigBee.

5. The method of claim 1, wherein the automated guided vehicle comprises a battery storage compartment, and charges the electric vehicle to be charged through a battery in the battery storage compartment.

6. The method of claim 1 wherein the battery is further configured to charge the automated guided vehicle.

7. A mobile charging system for implementing the method of claim 1 to 6, comprising: an automated guided vehicle, a mobile positioning platform, a battery storage compartment, a battery grabbing robot arm, an AC power plug, a power switcher, a charging robot arm, a charging plug, a master device, a communication device and a metering device, wherein
the master device is configured to transmit a movement instruction to the mobile positioning platform;
the mobile positioning platform is connected to the master device and configured to receive the movement instruction transmitted by the master device;
the automated guided vehicle is configured to automatically travel along a route which is preset according to the movement instruction by the mobile positioning platform;
the battery storage compartment is located in the automated guided vehicle and configured to store a battery, wherein the battery is configured to charge an electric vehicle to be charged;
the master device is configured to control the battery grabbing robot arm to grab the battery in the battery storage compartment;
the master device is further configured to control intelligent distribution for a power supply from the battery storage compartment;
the power switcher is configured to switch between the battery storage compartment and the AC power plug to switch between the power supplies from the battery storage compartment and the AC power plug for charging the electric vehicle;
the master device is further configured to control an operation of the charging robot arm;
the charging plug is connected to the charging robot arm and configured to charge the electric vehicle, wherein the charging robot arm is configured to enable the charging plug to be inserted into a charging socket of the electric vehicle;
the communication device is configured for communication between the master device and a background management system;
the metering device is connected to the master device, and is configured to meter a charging amount and a charging duration of the electric vehicle and transmit information about the charging amount and the charging duration to the master device; and
the master device is further configured to transmit user information and also order information generated from the information about the charging amount and the charging duration to a user through the background management system.

8. The system of claim 7, wherein the charging robot arm comprises an image recognition device, a control device, a manipulator and a motor drive device, wherein
the image recognition device is connected to the control device and configured to acquire image information;
the control device is connected to the motor drive device and configured to control the motor drive device according to the image information; and
the motor drive device is connected to the manipulator and configured to drive the manipulator to operate.

9. The system of claim 7, wherein the master device is configured to make route planning and an anti-collision design for the automated guided vehicle by means of electromagnetic induction guidance, laser guidance or visual guidance and control the automated guided vehicle.

10. The system of claim 7, wherein the battery is further configured to charge the automated guided vehicle.

11. The system of claim 7, wherein the power switcher is configured to be connected to the AC power plug when the electric vehicle to be charged is charged by an AC power supply, wherein the AC power plug is configured to be connected to the AC power supply.

12. A computer-readable storage medium, which is configured to store computer-executable instructions for executing the method of claim 1.
